(19) United States
(12) Patent Application Publication
(10) Pub. No.: US 2026/0169978 A1
(43) Pub. Date: Jun. 18, 2026

(54) COMPUTER SYSTEM DATA INTEGRITY

(71) Applicant: The PNC Financial Services Group, Inc., Pittsburgh, PA (US)

(72) Inventors: Jason L. Miller, Chandler, AZ (US); James W. Kies, Olathe, KS (US)

(21) Appl. No.: 19/380,322

(22) Filed: Nov. 5, 2025

Related U.S. Application Data
(60) Provisional application No. 63/734,423, filed on Dec. 16, 2024.

(51) Int. Cl. G06F 16/23; G06F 21/60

(52) U.S. Cl. CPC G06F 16/2365; G06F 21/602

(57) ABSTRACT

Computer-implemented systems and methods verify integrity of messages sent between components of an organization’s IT system. The data integrity process can use a high-dimensional Polybius square cipher to, with a specified key, cipher and then decipher messages, such as JSON messages. The ciphering and deciphering operations can be implemented with stored procedures that are stored “in memory” of the database system.

### PRIORITY CLAIM

The present application claims priority to United States provisional patent application Serial No. 63/734,423, filed December 16, 2024, titled “Computer System Data Integrity.”

### BACKGROUND

An enterprise computer system is commonly a large, integrated network of servers, applications, databases, and security mechanisms designed to support a company’s critical functions and enable seamless communication within and outside the organization. At the heart of the system are application servers, which run the main business applications, such as Customer Relationship Management (CRM) or Enterprise Resource Planning (ERP) software. These servers are responsible for processing business logic, handling data requests, and connecting to other core services in the system.

Supporting the application servers are dedicated database servers, which store the company’s structured data—everything from customer records and transaction histories to employee information. These databases, often powered by systems like MySQL, PostgreSQL, or Oracle, form the foundation of the enterprise’s data storage and are integral to processing the various requests that applications depend on. Web servers, meanwhile, act as the entry point for employees, customers, and partners to access applications through web browsers or APIs, handling requests and delivering web interfaces for easy access. Common web servers like Apache or Nginx serve as intermediaries, receiving and routing incoming requests to the correct application server.

File servers also play a key role by storing and managing unstructured data, such as documents and media files, which users access directly. Messaging queues such as RabbitMQ or Kafka are integral for ensuring that communication between applications and services is efficient and reliable. These messaging queues handle asynchronous tasks like data transfer and logging, allowing services to send, queue, and process tasks independently without direct, immediate dependencies on one another.

Other essential components include load balancers, which distribute incoming traffic across multiple servers to ensure that no single server becomes overloaded. This setup improves both system performance and resilience. Firewalls and security gateways protect the system’s perimeter, managing and filtering traffic to prevent unauthorized access. Intrusion detection systems and virtual private networks (VPNs) provide additional layers of security, particularly for remote access, allowing employees to connect securely from various locations. Authentication and authorization systems like LDAP or Active Directory manage user identities and permissions, ensuring that only authorized users can access specific data or services.

Monitoring and logging systems track the performance and health of the system, using tools like Prometheus, ELK Stack, and Grafana to detect anomalies, store log data, and allow administrators to troubleshoot or audit the system as needed. These logs provide a record of significant events, errors, and performance metrics, enabling proactive management and quick responses to potential issues.

The system is typically structured in layers. The presentation layer includes client devices and web servers, which handle requests and interface with the application layer where application servers execute business logic. These application servers interact closely with the data layer, consisting of database and file servers that handle both structured and unstructured data. A messaging layer, often represented by message queues, allows components to communicate asynchronously, which is essential for balancing system loads and reducing delays. Security and access controls run across the layers, enforcing strict authentication, authorization, and encryption policies at every level.

Each component in this multi-tiered architecture communicates over standardized protocols. Web-based services use HTTP or HTTPS, database access is managed via JDBC or ODBC, and message brokers use protocols such as AMQP or MQTT. LDAP handles authentication requests, while various logging and monitoring protocols support real-time data collection and reporting.

In such a setup, different types of messages flow constantly. For example, when a user initiates a request through a web application, a message containing their query is sent to the web server, which forwards it to the application server. The application server processes the query, interacts with the database if necessary, and returns a response message to the web server, which then delivers it to the user. Monitoring systems send regular heartbeat messages to confirm that components are running smoothly, and error messages are logged if any issues arise. Meanwhile, asynchronous tasks are processed by placing messages in a queue for worker services, which handle them independently and send updates on completion.

### SUMMARY

In one general aspect, the present invention is directed to computer-implemented systems and methods that verify the integrity of messages exchanged among components of an organization’s enterprise computing system. The data-integrity process employs a Polybius n-dimensional cipher—where n is greater than or equal to two—and a specified key to cipher and then decipher messages, such as JavaScript Object Notation (JSON) messages or other structured data formats, exchanged between components. The verification determines whether a message has been corrupted or altered by any of the system’s components, and when corruption is detected, the particular component or service responsible for the alteration can be identified.

The ciphering and deciphering operations can be implemented as stored procedures, e.g., precompiled collections of SQL statements and control-flow logic, stored within a database and executed by a database engine. Implementing the operations as stored procedures allows repetitive and computationally intensive ciphering and deciphering to be performed efficiently within the database system, encapsulating the logic into a single callable unit. The stored procedures can also be compiled and cached in volatile memory of the database engine for repeated execution. For example, the database engine may store the execution plan and compiled code for the ciphering and deciphering operations in memory, thereby reducing recompilation overhead and improving throughput and scalability. In some implementations, the stored procedures are persisted on disk within the database and dynamically loaded into volatile memory of the database engine at runtime. These and other technical advantages provided by embodiments of the present invention—such as reduced network latency, improved integrity-verification accuracy, and enhanced system reliability—will become apparent from the detailed description that follows.

### FIGURES

Various embodiments of the present invention are described by way of example in conjunction with the following figures.

FIG. 1 is a diagram of a database management system according to various embodiments of the present invention.

FIG. 2 shows a seven-by-seven keyed Polybius square cipher.

FIG. 3 shows a process for ciphering a plaintext message with a key according to various embodiments of the present invention.

FIG. 4 shows a process for deciphering a ciphertext according to various embodiments of the present invention.

FIG. 5 illustrate system in an organization’s IT system sending serially enriched messages.

FIG. 6 illustrates an example monitoring and alerting service in communication with the database management system according to various embodiments of the present invention.

### DESCRIPTION

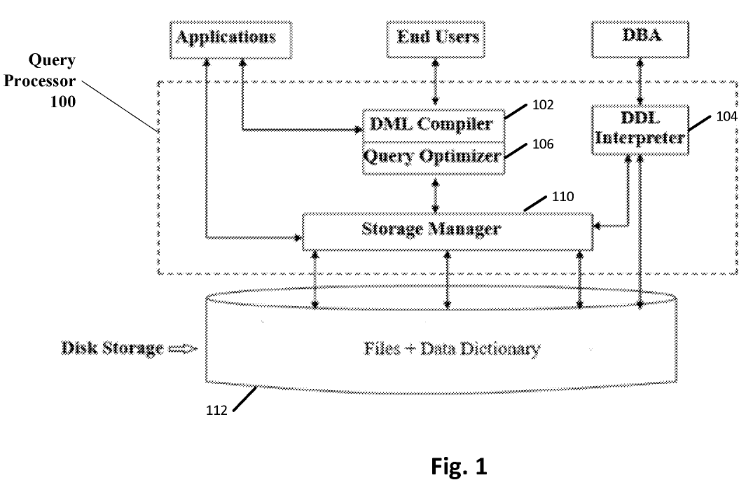

In various embodiments, the present invention is implemented with a database system that includes one or more processors, memory units, and a database engine (or database management system, DBMS) executed thereon. The database system executes one or more stored procedures to cipher and decipher messages in order to assess the integrity of message content exchanged among components of an enterprise computing environment. The database engine may correspond to the type of DBMS illustrated in FIG. 1, which manages stored data and provides interfaces for executing queries and stored procedures. A query processor 100 of the database engine receives queries or requests from other components or end users of the organization’s IT system and interprets those queries as executable instructions. The query processor 100 may include, among other modules, a data manipulation language (DML) compiler 102 that converts DML instructions into machine-executable operations; a data definition language (DDL) interpreter 104 that processes DDL instructions and maintains schema information in a data dictionary; a query optimizer 106 that selects an efficient execution plan from available alternatives; and, in some embodiments, an embedded DML pre-compiler that translates DML statements embedded in application programs into procedural function calls. Through this architecture, the database system can execute stored procedures that perform encryption, decryption, and integrity-verification operations directly within the database engine, thereby improving performance and reducing network overhead relative to performing such operations externally.

A storage manager 110 can act as the interface between the data stored in the database and the queries received by the query processor 100. This component in the structure of the DBMS can be responsible for the constraints applied to the data so that it remains consistent. It can also execute the DCL (Data Control Language) and encapsulates the following modules: an Authorization and Integrity Manager, which checks the authority of various users who access data and the Integrity Constraints of the database; a Transaction Manager, whose job is to assure the system remains in a proper state during the transaction process, and to ensure that concurrent transactions are executed without any conflict; a File Manager, which manages the space allocation of files in disk and data structures which stores information in the database; and a Buffer Manager, which manages the transfer of data between the secondary and main memory, as well as deciding what data should be cached in the memory.

The disk storage 112 represents the space where data are stored and it can have the following components: Files, which are responsible for storing the data; a Data Dictionary, which is a repository that maintains the information of the database object and maintains the metadata; and Indices, which are the keys that are used for faster retrieval of data. The database system can also comprise volatile memory, such as RAM, for temporary data storage and processing tasks.

Such a database, according to various embodiments, may execute stored procedures to cipher and decipher messages in the organization’s IT system to assess the integrity of the contents of the messages, e.g., assess whether some application or component of the IT system corrupted or inappropriately altered the content of a message. In various embodiments, the database uses a high-dimensional Polybius square cipher to, with a specified key, cipher and then decipher the messages, which can be JSON messages, for example. Before describing such a cipher, aspects of stored procedures are described.

In various embodiments, the database system can operate as an integrity-verification endpoint within a computing environment/system of an enterprise. When another component or service of the enterprise transmits a data message, transaction, or payload to the database system for processing or storage, the database engine can automatically invoke one or more stored procedures that apply the Polybius n-dimensional cipher to verify that the message has not been corrupted during transmission. The verification process can therefore be activated in response to receipt of the message by the database system, such as during execution of a data-insertion or update operation.

The database system may be, for example, a SQL Server, Oracle, or MySQL database, for example. It may run a stored procedure to implement the cipher and deciphering operations. The stored procedure can be a precompiled collection of SQL statements and optional control-flow logic, stored within the database, which can allow more efficient performance of the repetitive and complex ciphering/deciphering operations by encapsulating the logic into a single callable unit. The stored procedure is also preferably stored in memory. For example, when the database system first executes the stored procedures for ciphering and/or deciphering, the database system can compile it into an executable form and cache it in memory (e.g., RAM) for faster subsequent execution. The database engine (e.g., the query processor) can also store the execution plan and compiled code in memory, reducing the need for re-compilation. The stored procedures can be stored persistently in the database on a disk or other secondary storage of the database system and loaded into memory (e.g. RAM) during execution thereof. The stored procedure(s) written in Structured Query Language (SQL) or a procedural extension of SQL specific to the database management system (DBMS) being used. Some databases allow stored procedures to be written in general-purpose programming languages, such as Java, Python, C/C++ and JavaScript, especially in advanced or extensible DBMS systems:

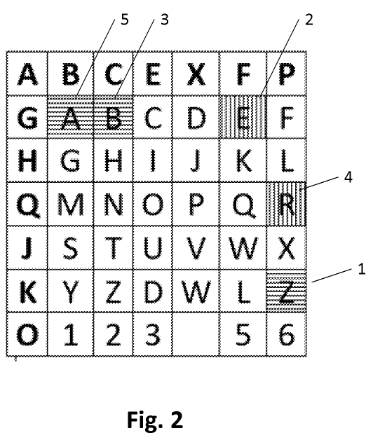

As mentioned herein, in various embodiments the database system’s stored procedure utilizes a Polybius cipher to cipher and then decipher the messages, using a key. A simple, square Polybius cipher with a key is shown for illustration purposes in FIG. 2. The illustrated example is a 7x7 grid. In this example, the key is “A B C E X F PG A B C D E FH G H I J K LQ M N O P Q RJ S T U V W XK Y Z D W L ZO 123 56,” which fills the cells of the grid in this example. If a key (with N elements) has fewer elements than cells of the grid, the first N cells of the grid could be populated with the key’s elements and then, starting with the N+1 cell, the cells could be filled respectively with A, B, C, and so on, until the grid cells are filled.

Using the cipher with a key as shown in FIG. 2, assumed that the coded message is “KPFGGCPQGB.” To decode this message, the first letter of the decoded message corresponds to the cell with the coordinates “KP,” which is this case is “Z” at cell 1, where K is in the first column and P is in the first row. This type of look-up can be called “horizontal” or “X.” The second character of the decoded message corresponds to “FG,” i.e., the second and third characters of the coded message, but this time F is in the top ow and G is in the first column, thereby corresponding to the decoded letter “E” at cell 2. This type of look-up can be called “vertical” or “Y.” Continuing with this example, and alternating between horizontal/X and vertical/Y lookups, the decoded message is “ZEBRA.” The characters decoded from horizontal/X lookup are shown with cells 1, 3, 5 in horizontal shading; and the characters decoded from the vertical/Y lookup are shown with cells 2, 4 in vertical shading.

The keyed tabled of FIG. 2 can also be used to generate a coded message from the input plaintext. For example, using the reverse process, the plaintext message “ZEBRA” can be coded as “KPFGGCPQGB.”.

Embodiments of the present invention preferably used a higher-order Polybius cipher (e.g., cube or hyper-cube) and a key (or keyword). In such higher-order ciphers, each letter or digit is represented by n coordinates, where n is the number of dimensions. For the sake of example, imagine a 5x5x5 cube, where each letter is represented by three coordinates (x, y, z). Because there are more cells (125) than letter/digits (36), each letter/number can be assigned to multiple 3-digit coordinates in the cube. For example, the keyword can be used to fill the first row of the 3D grid, with the remaining cells (if any) filled with the rest of the alphabet. Note that the keyword could be as large, or almost as large, as the number of cells in the cube/hypercube. With multiple representations of letters/digits in the cube, a letter/digit can have different starting positions within the grid. For example, the letter ‘A’ might be represented by (1,1,1), (2,3,4), and (5,5,5). Using a predetermined rule, for example, (e.g., odd-numbered letters use the first set of coordinates, even-numbered letters use the second set), coordinate triplets can be assigned to each letter/digit. To create the ciphertext for an incoming message, the plaintext letter/digit is converted to its corresponding triplet, for example, so that the ciphertext is a string of triplets. To decipher the ciphertext, it can be divided into the triplets, and then using the predetermined rule and the keyed cube, each triplet can be converted back to it corresponding letter/digit, which then can be combined for form the plaintext message.

For a n-order Polybius cipher (e.g., n = 3, 4, 5 …), each letter/digit would correspond to n coordinates. Embodiments of the present invention can use a value for n that is greater than 3. As the dimensions increase, the complexity of the cipher grows exponentially, which can make both ciphering and deciphering more computationally intensive. Also, a higher-dimensional cipher preferably uses a more complex key to define the mapping between letters and coordinates, which key must be securely shared between the sender and receiver to perform both the ciphering and deciphering. In various embodiments, the key could be hundreds of characters in length, or even more than one thousand characters in length. An organization could use a single key for a specified time period. That way, the ciphertext for a message send during the specified time period can be deciphered, at any later time, using the key for the time period when the message was sent. In other embodiments, the key could be based, additionally or alternatively, upon other parameters besides time of message, such as one or more of message type, the team in the organization to which the message pertains, the process or application used to generate the message, etc. In fact, each message could have it own key, but practically that would require a database to store the keys by message ID.

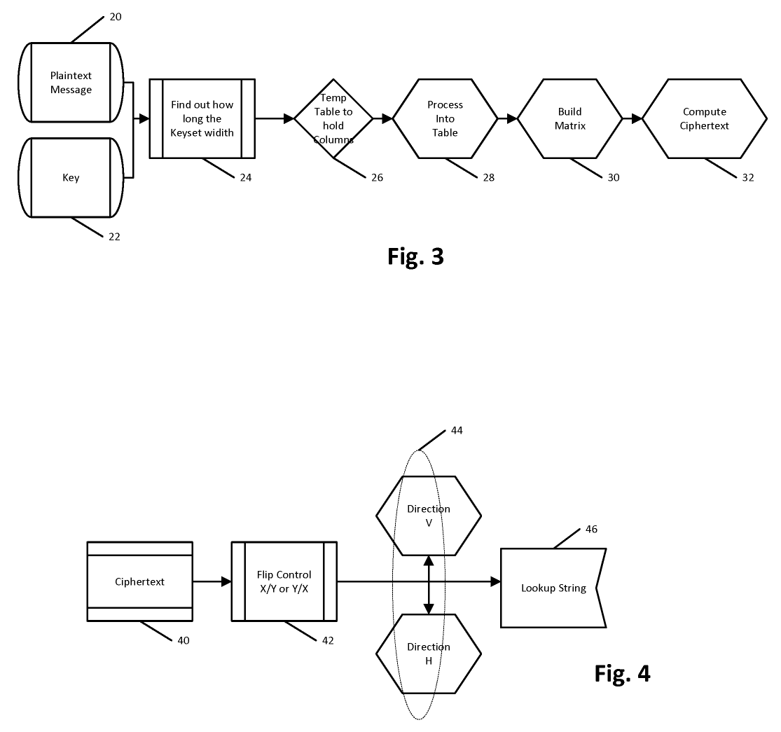

FIG. 3 shows steps of process for creating the ciphertext for a message 20 according to various embodiments of the invention. This example can use a multi-dimensional keyed cipher, such as like the 2-dimensional keyed cipher shown in FIG. 2 or a higher dimensional cipher. As shown in the example of FIG. 3, the inputs to the ciphering process, which can be performed by the database’s stored procedure as described above, are the message 20 to be coded and the key 22. The key 22 could be stored in a look-up table, for example. At block 24, the stored procedure can determine the length of the key 22. Then at block 26, the stored procedure builds a temporary table to hold the columns for the grid/cube of the cipher. Next, at block 28, the stored procedure loads the cipherkey from the temporary table into a table. At step 30, the stored procedure builds the matrix/n-cube. Having now constructed the matrix for the key 22, the stored procedure at step 32 can compute the ciphertext for the message 20, such as described above in connection with FIG. 2. The ciphering process preferably can alternate between horizontal/X and vertical/Y lookups.

FIG. 4 shows a process for deciphering a coded message, e.g., a ciphertext 40. Assume for purposes of this example that the cipher is n-dimensional so that the ciphertext is a string of n-character words. At block 42 the store procedure can flip control x/y or y/x. For example, the first n-character word can be decoded using a horizontal lookup, the second n-character word can be decoded using a vertical lookup, and so on in an alternating fashion. At block 44 the stored procedure can traverse the matrix/cube in the vertical or horizontal directions at the case may be (as determined at block 42) so that, at block 46, the decoded message string can be looked up. If the ciphertext 40 corresponds faithfully to ciphertext 32 generated by the ciphering process of FIG. 3, the decoded message at block 46 should match the plaintext message 20 input to the ciphering process, assuming that the same key was used for the ciphering and deciphering processes. Also, if the ciphertext 32 is transmitted between systems, components, applications, etc. as the case may be of the organization’s IT system, it is essentially gibberish without the key to decipher it or cracking the cipher code, which can be practically impossible for a complex, multi-dimensional Polybius cipher and a long keyword.

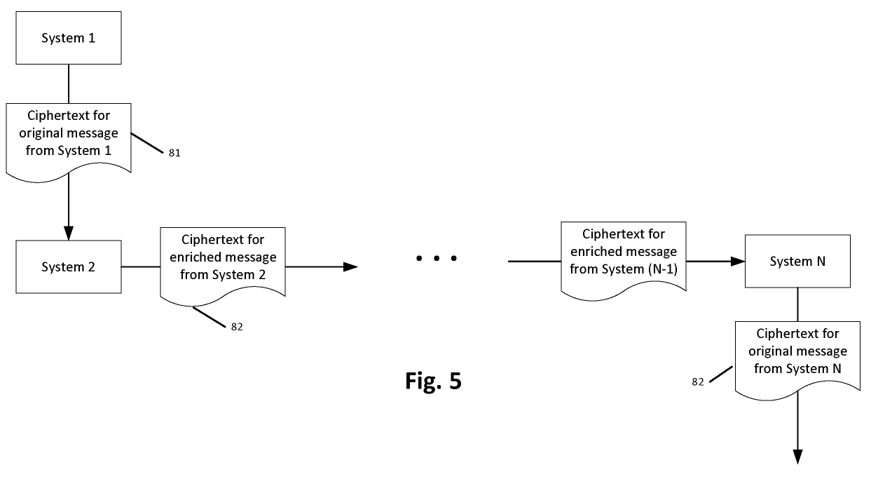

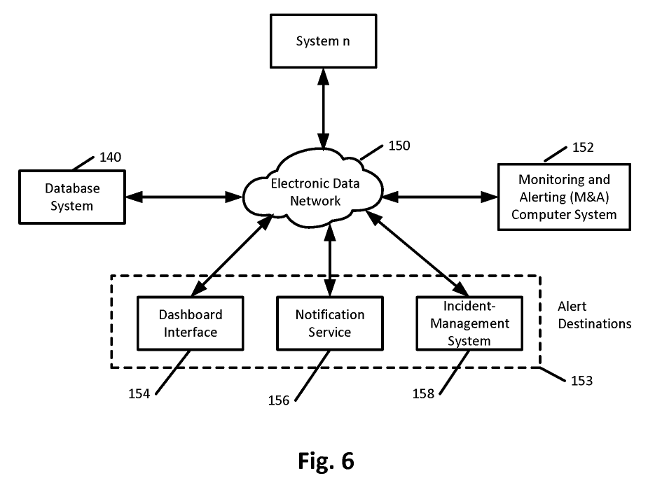

With reference to FIG. 5, at an organizational level, when system 1 of a organization’s IT system sends a message (e.g., a JSON) message to system 2, the message may be ciphered and deciphered using the techniques described herein. In some embodiments, each participating system (1 through N) communicates with the database system (e.g., the database system 140 of FIG. 6) that executes stored procedures implementing the Polybius n-dimensional cipher on behalf of the systems. For example, before sending a message, System 1 may invoke, at step 81, a stored procedure of the database system to generate a ciphertext of its original message, and System 2 may call another stored procedure to decipher the received message. System 2 can then, at step 82, enrich the message—e.g., by adding context or supplemental data—and optionally re-invoke the database system to generate a ciphertext of the enriched message for downstream transmission. This process can continue through System N, such that the message is enriched (N-1) times, and the Nth system outputs, at step 83, a ciphertext corresponding to its received and enriched message. The verification process can operate in reverse order to confirm message integrity at each stage; if a discrepancy is detected, the monitoring and alerting system can identify the particular system responsible for introducing the corruption. The systems 1 through N of FIG. 5 may include, for example, web applications, mobile apps, microservices, API gateways, data-processing pipelines, message queues, logging systems, configuration-management tools, database systems, cloud services, IoT devices, business-intelligence platforms, or machine-learning pipelines. The exchanged messages may comprise, for example, JSON messages or other structured data formats sent between systems.

When a discrepancy is detected between a decoded message and its corresponding input message, the database system can generate a message-integrity status indicator identifying the message and the occurrence of an integrity failure. The database system stores the message-integrity status indicators in the database, together with associated metadata such as a timestamp, message identifier, and source-component information. As shown in FIG. 6, these status indicators can be retrieved or received by a monitoring and alerting (M&A) computer system 152, implementing a M&A service, over an electronic data network 150 of the enterprise. In some embodiments, the M&A service 152 periodically calls or subscribes to an interface of the database system 140 to obtain the message-integrity status indicators, while in other embodiments the database system 140 automatically transmits the indicators to the M&A service 152 as they are generated. The M&A service 152 can analyze the message-integrity status indicators received from the database system 140 to determine where message corruption or transmission errors are occurring within the enterprise computing environment. Based on this analysis, the M&A service 152 can generate and send an appropriate electronic alert, which may indicate the affected component, the severity of the detected error, and suggested remedial actions.

The M&A service 152 can communicate with one or more alert destinations 153, such as a dashboard interface 154, notification service 156, or incident-management system 158, which receive the alerts for presentation or further handling. The electronic data network 150 may represent any local-area network, wide-area network, or cloud-based infrastructure that interconnects the database system 140, the M&A service 152, and the alert destinations 153. In some implementations, the M&A service 152 may also maintain a historical log of message-integrity status indicators to identify recurring or systemic sources of message corruption over time.

In various embodiments, a key-management service of the enterprise computing system distributes and synchronizes encryption keys used by the database system and other participating components. The key-management service can generate the key according to a defined key-rotation policy, assign a unique identifier to each key instance, and maintain an audit log of key-generation and distribution events. When a new key is created, the key-management service can securely transmit it to the database system and to any component authorized to generate or verify ciphered messages. Key exchange can be implemented using secure network protocols such as TLS or SSH-based key exchange. The database system may store the received key in a protected key store or credential vault accessible to the database engine during stored-procedure execution. This configuration ensures that both sender and database system use the same key for ciphering and deciphering operations while maintaining centralized control and traceability of key usage across the enterprise.

The verification process can be automatically initiated by the database system in response to a triggering event associated with message flow within the enterprise computing system. In some embodiments, the trigger corresponds to the receipt of a data-insertion, update, or synchronization request that includes an input message to be stored or processed. In other embodiments, a middleware process, message broker, or event-driven workflow may explicitly invoke the stored procedure through a database call or API request. The trigger may also be periodic, such as a scheduled integrity audit that re-verifies messages already stored in the database. This automatic activation eliminates the need for manual invocation and ensures that message-integrity verification occurs continuously during normal operation of the enterprise computing environment.

In certain embodiments, the monitoring and alerting computer system 152 classifies detected message-integrity failures according to severity levels or categories. The classification may be based on one or more attributes of the message-integrity status indicator, such as the originating component, the number of consecutive failures detected, the type of message affected, or the business-criticality of the associated process. For example, repeated corruption events from a data-ingestion microservice may be classified as a high-severity alert, while a single transient mismatch in a noncritical telemetry message may be classified as a low-severity alert. The severity level may influence the type of alert generated, the notification channel selected, or the escalation path applied by an incident-management system. This structured classification allows the enterprise to prioritize remediation efforts and minimize downtime caused by message corruption.

The electronic data network interconnecting the database system 140, the monitoring and alerting computer system 152, and other enterprise components can use any suitable communication protocol supporting secure and reliable data transmission. In certain embodiments, the database system exposes an application programming interface (API) for transmitting message-integrity status indicators to the monitoring and alerting computer system. The communication may employ RESTful API calls or gRPC-based remote procedure calls, both secured using Transport Layer Security (TLS) encryption. Alternatively, the components may exchange messages over an enterprise message bus or publish–subscribe infrastructure such as Kafka, RabbitMQ, or AWS SNS. These standardized communication protocols enable the monitoring and alerting computer system to operate independently of the specific database implementation while ensuring end-to-end confidentiality and integrity of transmitted data.

Performing the ciphering and deciphering operations within the database engine as stored procedures provides measurable performance and efficiency benefits relative to external verification mechanisms. Because the stored procedures are precompiled and cached in memory, execution avoids the overhead of context switching and external network calls typically required by separate verification services. This in-database execution reduces network latency, minimizes bandwidth consumption, and leverages database-native parallel processing for high throughput. Additionally, by performing integrity verification close to where data is stored, the system reduces the risk of message tampering in transit and avoids unnecessary duplication of data across services. These technical advantages contribute to improved overall system performance, scalability, and security within the enterprise computing environment.

In one general aspect, therefore, the present invention is directed to a database system operable within an enterprise computing system. The database system comprises one or more processors and one or more memory units, a database engine executed by the one or more processors and the one or more memory units, a database managed by the database engine. The database engine is configured to: execute a first stored procedure to generate a first ciphertext from an input message based on a Polybius n-dimensional cipher and a key, where n is greater than or equal to 2, and where the input message is received by the database system from another component of the enterprise computing system; execute a second stored procedure to generate a decoded message by applying the same Polybius n-dimensional cipher and the key to a second ciphertext; and perform a comparison of the decoded message to the input message to verify integrity of the input message so as to detect corruption of messages exchanged among components of the enterprise computing system. The first and second stored procedures each can comprise a precompiled routine stored in the database and executable by the database engine upon invocation within the database engine.

According to another general aspect, the present invention is directed to a computer-implemented method for verifying message integrity within an enterprise computing system. The method comprises, according to various embodiments, executing, by a database engine of a database system of the enterprise computing system, a first stored procedure to generate a first ciphertext from an input message based on a Polybius n-dimensional cipher and a key, where n is greater than or equal to 2, and wherein the input message is received by the database system from another component of the enterprise computing system. The method also comprises the step of executing, by the database engine, a second stored procedure to generate a decoded message by applying the same Polybius n-dimensional cipher and the key to a second ciphertext. The method also comprises the step of comparing, by the database engine, the decoded message to the input message to verify integrity of the input message. And the method also comprises the step of generating, upon detection that the decoded message differs from the input message, a message-integrity status indicator that is stored in a database managed by the database engine.

In various implementations, executing the first stored procedure can comprise building a temporary table and an n-dimensional matrix defining coordinate mappings of the Polybius n-dimensional cipher.

In various implementations, the key is selected based on at least one of a time period, a message type, or an identifier of a component of the enterprise computing system.

In various implementations, the key is retrieved from a key-lookup table stored in the database.

In various implementations, the stored procedures are compiled and cached in volatile memory of the database system for repeated execution.

In various implementations, the database engine alternates between horizontal and vertical coordinate lookups when generating the ciphertext and/or when decoding the ciphertext.

In various implementations, the first and second stored procedures are invoked through a database call issued by a second component of the enterprise computing system.

In various implementations, the database engine is further configured to generate, based on the comparison, a message-integrity status indicator that is stored in the database. In such an embodiment, the database engine can be further configured to transmit the message-integrity status indicator to a monitoring and alerting service of the enterprise computing system.

In various implementations, n is an integer from 2 to 10. For example, n can be 3 and the Polybius n-dimensional cipher comprises a three-dimensional Polybius cube cipher.

In various implementations, the input message comprises a JavaScript Object Notation (JSON) message that includes one or more data fields subject to integrity verification by the database engine

In various implementations, the database engine is further configured to periodically regenerate the key based on a defined key-rotation interval or upon detection of a message-integrity failure.

In another general aspect, the present invention is directed to an enterprise computing system comprising a database system and a monitoring and alerting computer system. The database system comprises: one or more processors and one or more memory units; a database engine executed by the one or more processors and the one or more memory units; and a database managed by the database engine. The database engine is configured to: execute a first stored procedure to generate a first ciphertext from an input message based on a Polybius n-dimensional cipher and a key, where n is greater than or equal to 2, and wherein the input message is received by the database system from another component of the enterprise computing system; execute a second stored procedure to generate a decoded message by applying the same Polybius n-dimensional cipher and the key to a second ciphertext; compare the decoded message to the input message to verify integrity of the input message; and generate, upon detection that the decoded message differs from the input message, a message-integrity status indicator that is stored in the database. The first and second stored procedures each comprise a precompiled routine stored in the database and executable by the database engine upon invocation within the database engine. The monitoring and alerting computer system is in communication with the database system via an electronic data network of the enterprise computing system. The monitoring and alerting computer system is configured to: receive the message-integrity status indicator from the database system via the electronic data network; perform an analysis of the message-integrity status indicator to identify a location of a corruption error within the enterprise computing system; and generate and transmit an electronic alert to one or more alert destinations based on the analysis.

In various implementations, executing the first stored procedure comprises building a temporary table and an n-dimensional matrix defining coordinate mappings of the Polybius n-dimensional cipher.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A database system operable within an enterprise computing system, the database system comprising:
one or more processors and one or more memory units;
a database engine executed by the one or more processors and the one or more memory units; and
a database managed by the database engine, wherein:
the database engine is configured to:
execute a first stored procedure to generate a first ciphertext from an input message based on a Polybius n-dimensional cipher and a key, where n is greater than or equal to 2, wherein the input message is received by the database system from another component of the enterprise computing system;
execute a second stored procedure to generate a decoded message by applying the same Polybius n-dimensional cipher and the key to a second ciphertext; and
perform a comparison of the decoded message to the input message to verify integrity of the input message so as to detect corruption of messages exchanged among components of the enterprise computing system; and
the first and second stored procedures each comprise a precompiled routine stored in the database and executable by the database engine upon invocation within the database engine.

2. The database system of claim 1, wherein executing the first stored procedure comprises building a temporary table and an n-dimensional matrix defining coordinate mappings of the Polybius n-dimensional cipher.

3. The database system of claim 1, wherein the key is selected based on at least one of a time period, a message type, or an identifier of a component of the enterprise computing system.

4. The database system of claim 1, wherein the key is retrieved from a key-lookup table stored in the database.

5. The database system of claim 1, wherein the stored procedures are compiled and cached in volatile memory of the database system for repeated execution.

6. The database system of claim 1, wherein the database engine alternates between horizontal and vertical coordinate lookups when generating the ciphertext.

7. The database system of claim 6, wherein the database engine alternates between horizontal and vertical coordinate lookups when decoding the ciphertext.

8. The database system of claim 1, wherein the first and second stored procedures are invoked through a database call issued by a second component of the enterprise computing system.

9. The database system of claim 1, wherein the database engine is further configured to generate, based on the comparison, a message-integrity status indicator that is stored in the database.

10. The database system of claim 9, wherein the database engine is further configured to transmit the message-integrity status indicator to a monitoring and alerting service of the enterprise computing system.

11. The database system of claim 1, wherein n is 3 and the Polybius n-dimensional cipher comprises a three-dimensional Polybius cube cipher.

12. The database system of claim 1, wherein n is an integer from 2 to 10.

13. The database system of claim 1, wherein the input message comprises a JavaScript Object Notation (JSON) message that includes one or more data fields subject to integrity verification by the database engine

14. The database system of claim 1, wherein the database engine is further configured to periodically regenerate the key based on a defined key-rotation interval or upon detection of a message-integrity failure.

15. An enterprise computing system comprising:
a database system that comprises:
one or more processors and one or more memory units;
a database engine executed by the one or more processors and the one or more memory units; and
a database managed by the database engine, wherein:
the database engine is configured to:
execute a first stored procedure to generate a first ciphertext from an input message based on a Polybius n-dimensional cipher and a key, where n is greater than or equal to 2, and wherein the input message is received by the database system from another component of the enterprise computing system;
execute a second stored procedure to generate a decoded message by applying the same Polybius n-dimensional cipher and the key to a second ciphertext;
compare the decoded message to the input message to verify integrity of the input message; and
generate, upon detection that the decoded message differs from the input message, a message-integrity status indicator that is stored in the database; and
the first and second stored procedures each comprise a precompiled routine stored in the database and executable by the database engine upon invocation within the database engine; and
a monitoring and alerting computer system in communication with the database system via an electronic data network of the enterprise computing system, wherein the monitoring and alerting computer system is configured to:
receive the message-integrity status indicator from the database system via the electronic data network;
perform an analysis of the message-integrity status indicator to identify a location of a corruption error within the enterprise computing system; and
generate and transmit an electronic alert to one or more alert destinations based on the analysis.

16. A computer-implemented method for verifying message integrity within an enterprise computing system, the method comprising:
executing, by a database engine of a database system of the enterprise computing system, a first stored procedure to generate a first ciphertext from an input message based on a Polybius n-dimensional cipher and a key, where n is greater than or equal to 2, and wherein the input message is received by the database system from another component of the enterprise computing system;
executing, by the database engine, a second stored procedure to generate a decoded message by applying the same Polybius n-dimensional cipher and the key to a second ciphertext;
comparing, by the database engine, the decoded message to the input message to verify integrity of the input message; and
generating, upon detection that the decoded message differs from the input message, a message-integrity status indicator that is stored in a database managed by the database engine.

17. The method of claim 16, wherein executing the first stored procedure comprises building a temporary table and an n-dimensional matrix defining coordinate mappings of the Polybius n-dimensional cipher.

18. The method of claim 16, wherein the key is selected based on at least one of a time period, a message type, or an identifier of a component of the enterprise computing system.

19. The method of claim 16, further comprising caching the first and second stored procedures in volatile memory of the database system for repeated execution.

20. The method of claim 16, further comprising:
receiving, by a monitoring and alerting computer system via an electronic data network, the message-integrity status indicator from the database system;
performing an analysis, by the monitoring and alerting computer system, the message-integrity status indicator to identify a location of a corruption error within the enterprise computing system; and
generating and transmitting, by the monitoring and alerting computer system, an electronic alert to one or more alert destinations based on the analysis.
